(19) United States
(12) Patent Application Publication
(10) Pub. No.: US 2025/0120343 A1
(43) Pub. Date: Apr. 17, 2025

(54) OPERATOR SUSPENSION

(71) Applicant: Excel Industries, Inc., Hesston, KS (US)

(72) Inventors: Hunter A. Veith, Hesston, KS (US); James A. Wright, Hesston, KS (US)

(21) Appl. No.: 18/916,902

(22) Filed: Oct. 16, 2024

Related U.S. Application Data
(60) Provisional application No. 63/544,344, filed on Oct. 16, 2023.

(51) Int. Cl. A01D 67/04; A01D 34/64; A01D 101/00

(52) U.S. Cl. CPC A01D 67/04; A01D 34/64; A01D 2101/00

(57) ABSTRACT

Provided is a vehicle comprising a frame and a suspension. The suspension has a platform, a spring assembly, and an adjustment. The platform has a front rotatably engaged to the frame and a rear. The spring assembly has a top engaged to the platform rear and a bottom engaged to the adjustment. The adjustment has a lever having a fulcrum, a lever output rotatably engaged to the spring assembly bottom, a lever input fixed in orientation with respect to the lever output, the lever input having a locking feature to hold the lever input fixed with respect to the fulcrum, and a platen, the platen defining a plurality of sites adapted to interface with the locking feature to lock the lever input with respect to the fulcrum; and wherein each site corresponds to a different pre-load on the spring assembly.

### CROSS-REFERENCE TO RELATED APPLICATIONS

This application claims the benefit of U.S. Provisional Application No. 63/544,344, filed Oct. 16, 2023, which is hereby incorporated in its entirety by reference.

### FIELD OF DISCLOSURE

The disclosed subject matter pertains to power equipment devices with a seat for an operator. More specifically, the disclosed subject matter pertains to a seat or other apparatus adapted to support an associated operator of a power equipment device, the seat adapted to move with respect to the power equipment device while in operation. Even more specifically, the disclosed subject matter is directed to a suspension for a seat or other apparatus adapted to support an associated operator of a power equipment device.

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly.

For example, lawn maintenance vehicles operate on a variety of surfaces or varying roughness, for varying applications, and with associated operators thereof of varying size and mass.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

In one or more aspects of disclosed embodiments, disclosed is a lawn maintenance vehicle comprising a frame and an operator suspension. The operator suspension has a platform; a spring-damper assembly, and an adjustment assembly. The platform has a platform front and a platform rear offset from the platform front in the depth direction by a platform depth, the platform front rotatably engaged to the frame such that the platform may rotate about a front support axis, the front support axis being fixed in position with respect to the frame and the platform. The spring-damper assembly is elongated to define a spring-damper assembly top offset from a spring-damper assembly bottom by a variable spring-damper assembly length, the spring-damper assembly top operationally being engaged to the platform rear, the spring-damper assembly bottom being operationally engaged to the adjustment assembly. The adjustment assembly has an adjustment lever having a fulcrum pivotable about a fulcrum axis, the fulcrum axis being fixed to the frame, a lever output end offset from the fulcrum by a lever output length, the lever output end being rotatably engaged to the slider bottom, a lever input end offset from the fulcrum by a lever input length, the lever input end being fixed in orientation about the fulcrum axis with respect to the lever output end, the lever input end having an adjustable locking feature to permit the orientation of the lever input end to be selectably fixed with respect to the fulcrum axis, and an adjustment platen fixed in position and orientation with respect to the frame, the adjustment platen defining a plurality of fixed lock sites, each lock site adapted to operationally interface with the adjustable locking feature to lock the lever input end at a corresponding orientation with respect to the fulcrum axis; and wherein each lock site corresponds to a different pre-load on the spring-damper assembly.

In another disclosed embodiment, provided is a riding mower comprising a frame, the frame having a frame front and a frame rear offset from the frame front in a depth direction by a frame depth, a frame right and a frame left offset from the frame right in a width direction by a frame width, and a frame top and a frame bottom offset from the top in a height direction by a frame height; an operator suspension having, a platform having a platform front and a platform rear offset from the platform front in the depth direction by a platform depth, the platform front rotatably engaged to the frame such that the platform may rotate about a front support axis, the front support axis being fixed in position with respect to the frame and the platform, an elongated coil-over-shock assembly defining a coil-over-shock assembly top offset from a coil-over-shock assembly bottom by a variable coil-over-shock assembly length, the coil-over-shock assembly top rotatably engaged to the platform rear, the coil-over-shock assembly bottom rotatably engaged to an adjustment assembly, the adjustment assembly having an adjustment lever having a fulcrum pivotable about a fulcrum axis, the fulcrum axis fixed to the frame, a lever output end offset from the fulcrum by a lever output length, the lever output end being rotatably engaged to the coil-over-shock assembly bottom, a lever input end offset from the fulcrum by a lever input length, the lever input end being fixed in orientation about the fulcrum axis with respect to the lever output end, the lever input end having an adjustable locking pin to permit the orientation of the lever input end to be selectably fixed with respect to the fulcrum axis, and an arcuate adjustment platen centered on the fulcrum and fixed in position and orientation with respect to the frame, the adjustment platen defining a plurality of fixed holes, each hole adapted to operationally receive the adjustable locking pin to lock the lever input end at a corresponding orientation with respect to the fulcrum axis, and wherein each hole corresponds to a different pre-load on the coil-over-shock assembly; and a plurality of wheels operatively coupled to the frame and adapted to support the frame above a surface during operation; an operator seat operatively coupled to the platform; and wherein when the pin is engaged with any fixed hole, the lever input end is fixed with respect to the fulcrum axis thereby holding the pre-load on the coil-over-shock assembly fixed, and when the pin is not engaged with any fixed hole, the lever input end is free to rotate about the fulcrum axis, thereby permitting the pre-load on the coil-over-shock assembly to be changed.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 provides an example lawn maintenance vehicle according to one or more aspects of the present disclosure.

FIG. 2 is a cross-section side view of an operator suspension with a seat according to one aspect of the present subject matter.

FIG. 3 is a side view of the operator suspension of FIG. 2.

FIG. 4 is a top view of a sub-assembly of a lawn maintenance vehicle having an operator suspension with a seat according to one aspect of the present subject matter.

FIG. 5 is a side view of an operator suspension with a seat connected to a frame in a first configuration according to one aspect of the present subject matter.

FIG. 6 is a cross-section side view of the operator suspension with a seat connected to a frame in a first configuration of FIG. 5.

FIG. 7 is a side view of an operator suspension with a seat connected to a frame in a second configuration according to one aspect of the present subject matter.

FIG. 8 is a cross-section side view of the operator suspension with a seat connected to a frame in a second configuration of FIG. 7.

FIG. 9 is an elevated rear perspective view of an operator suspension with a seat connected to a frame in a second configuration according to one aspect of the present subject matter.

FIG. 10 is an exploded view of an operator suspension with a seat according to one aspect of the present subject matter.

FIG. 11 is an elevated perspective view of an operator suspension with a seat connected to a frame in a second configuration according to one aspect of the present subject matter.

FIG. 12 is an exploded perspective view of a spring-damper assembly and adjustment assembly according to one aspect of the present subject matter.

FIG. 13 is a close-up isometric perspective view of an operator suspension with a seat connected to a frame in a second configuration according to one aspect of the present subject matter.

FIG. 14 is a close-up side view of an operator suspension with a seat connected to a frame in a second configuration according to one aspect of the present subject matter.

FIG. 15 is a close-up rear perspective view of an operator suspension with a seat connected to a frame in a second configuration according to one aspect of the present subject matter.

FIG. 16 is a close-up rear perspective view of an operator suspension with a seat connected to a frame in a second configuration according to one aspect of the present subject matter.

FIG. 17 is an isometric block diagram showing related directions and dimensions.

It should be noted that the drawings are diagrammatic and not drawn to scale. Relative dimensions and proportions of parts of the figures have been shown exaggerated or reduced in size for the sake of clarity and convenience in the drawings. The same reference numbers may be used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to lawn maintenance vehicles and operator suspension for lawn maintenance vehicles are described herein, it should be understood that the disclosed machines, components, attachments and the like are not so limited and modifications may be made without departing from the scope of the present disclosure. The scope of the disclosed lawn maintenance vehicles, components and attachments are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms, “outdoor power equipment”, “outdoor power equipment machine”, “power equipment”, “maintenance machine” and “power equipment machine” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheelbarrows, lawn mowers, lawn maintenance vehicle, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

As utilized herein, relative terms or terms of degree such as approximately, substantially or like relative terms such as about, roughly and so forth, are intended to incorporate ranges and variations about a qualified term reasonably encountered by one of ordinary skill in the art in fabricating or compiling the embodiments disclosed herein, where not explicitly specified otherwise. For instance, a relative term can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, relative terminology can refer to a variation in a disclosed value or characteristic, e.g. a zero to five-percent variance or a zero to ten-percent variance from precise mathematically defined value or characteristic, or any suitable value or range there between can define a scope for a disclosed term of degree.

The applicant has learned it is desirable to permit a suspension for a seat or other support for an associated operator to be adjustable not just to suit operator size but also mass. The applicant has also learned it is also relevant for a suspension for a seat or other support for an associated operator to be adjustable to change the natural frequency of the suspension. The applicant has further learned it is of interest that the suspension permit the latter adjustment while still preventing undesirable shake, shift, rotation, vibration or other motion.

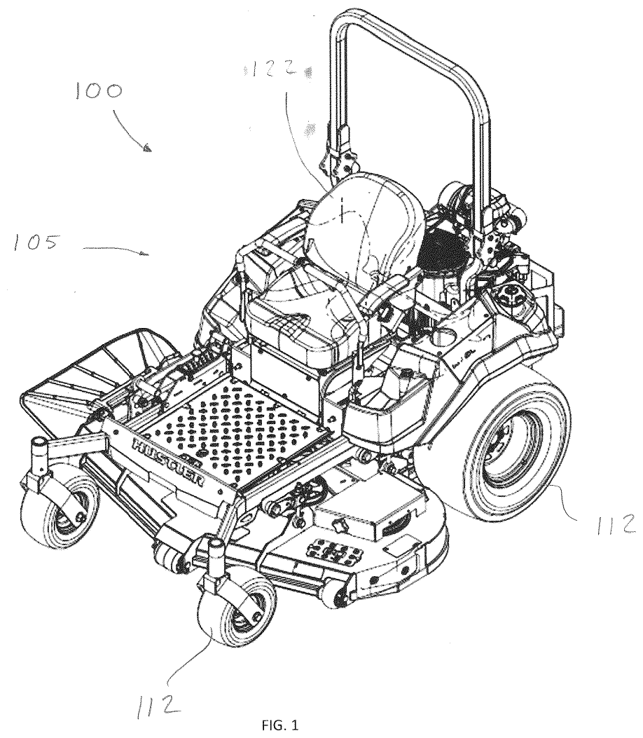

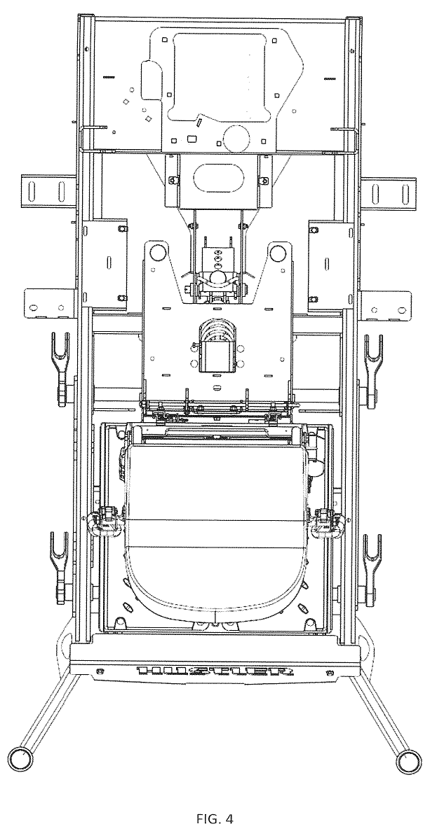

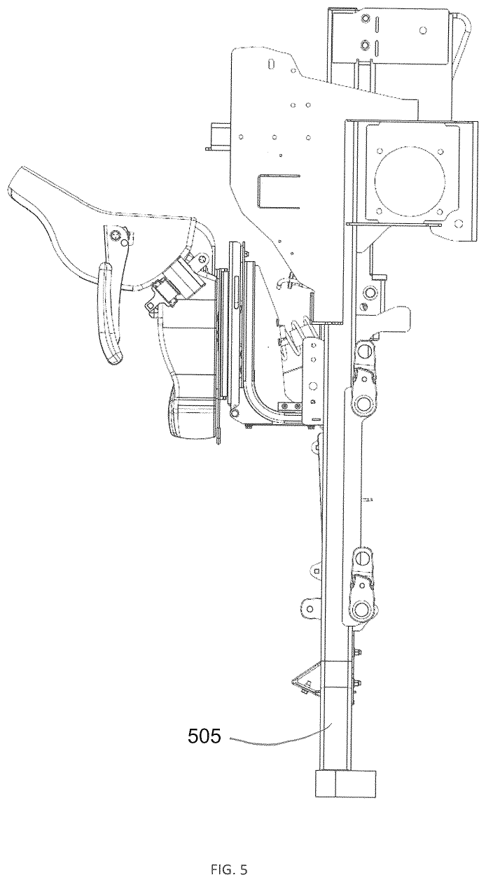

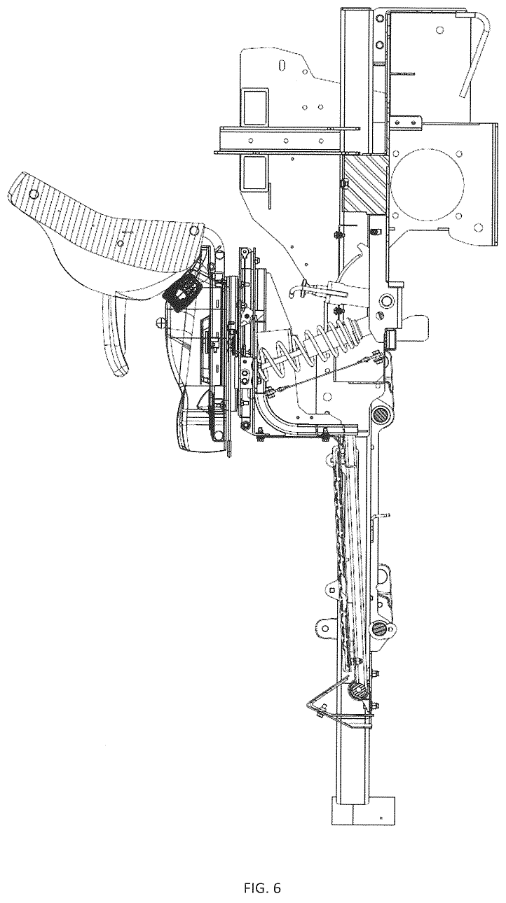

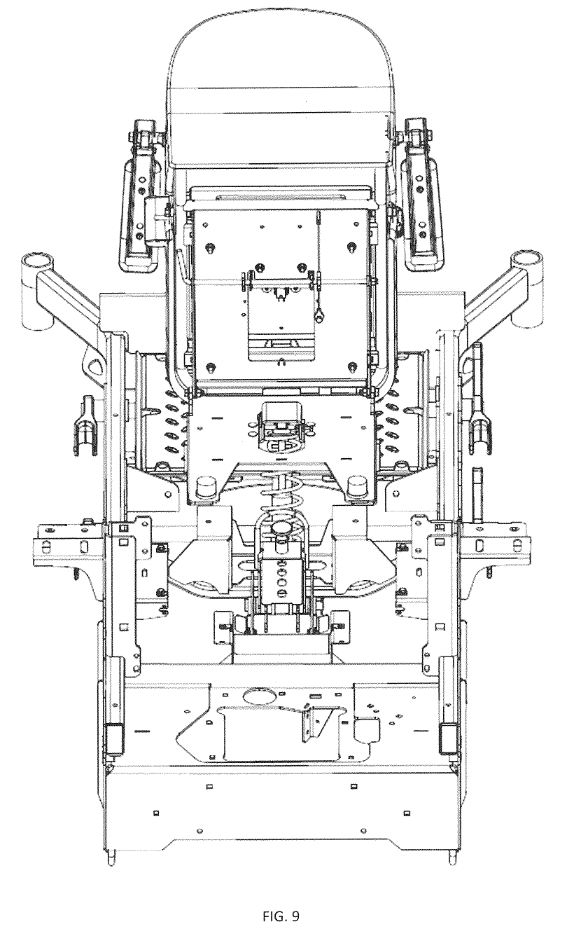

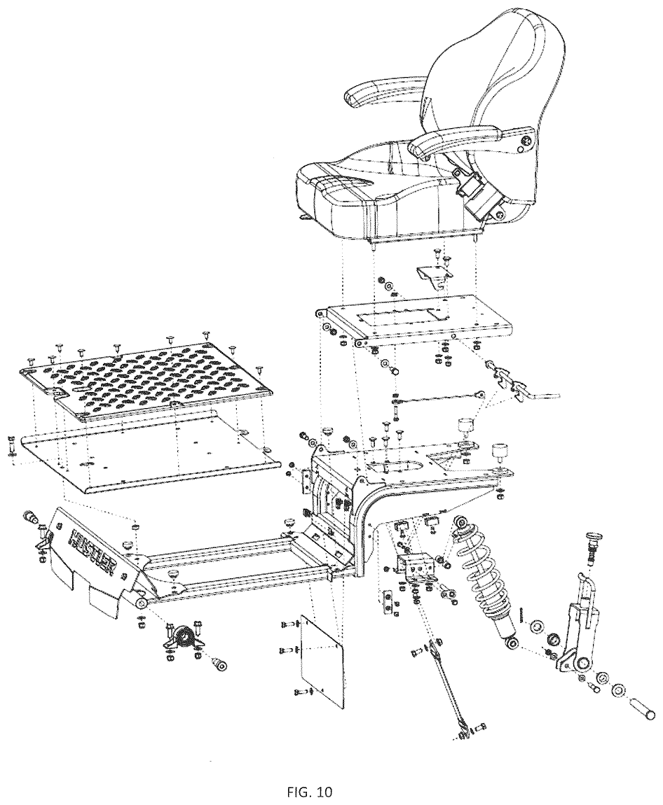

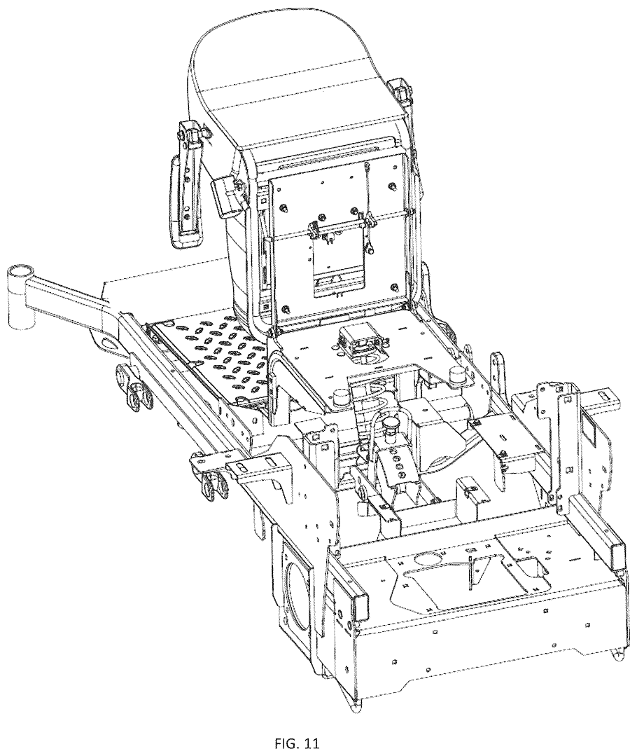

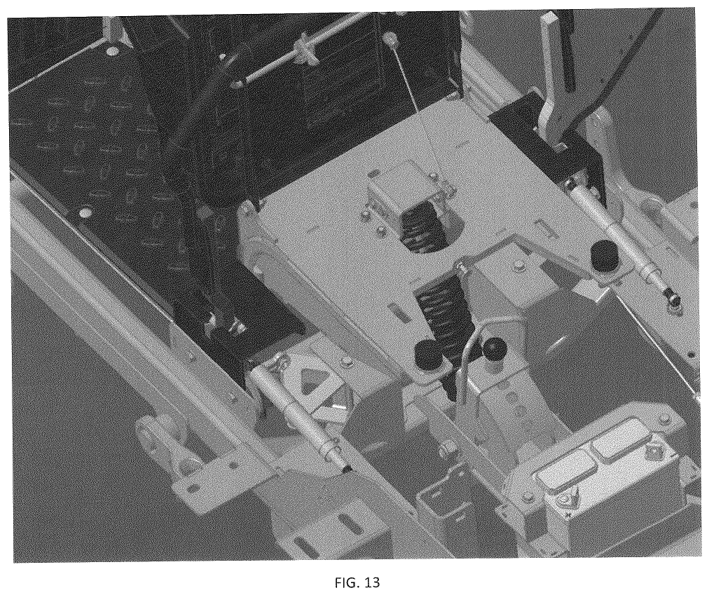

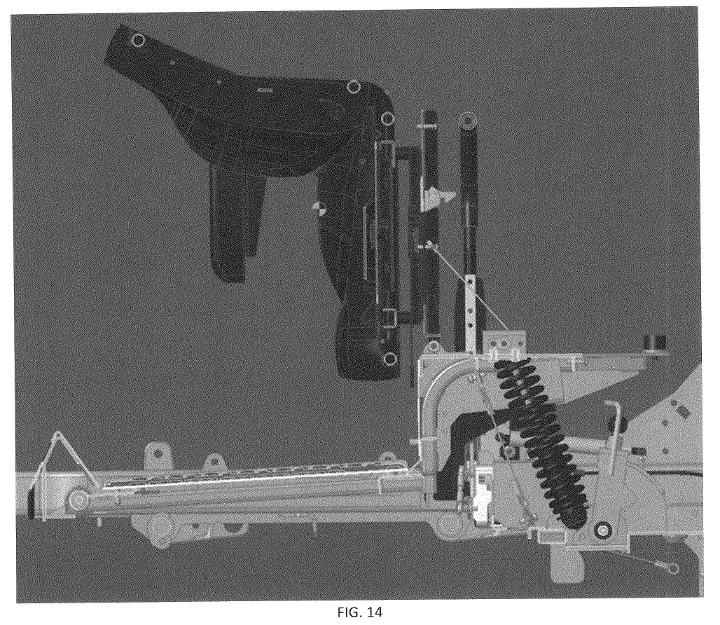

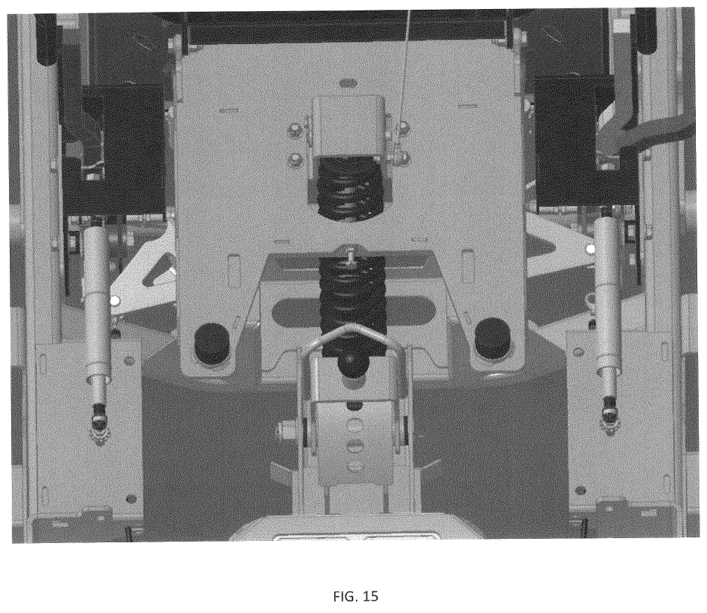

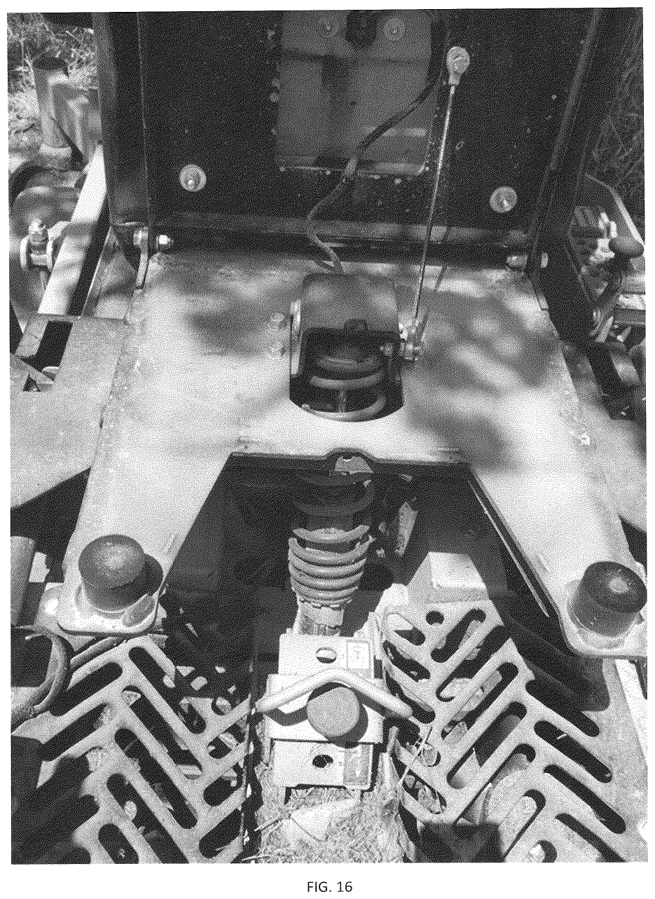

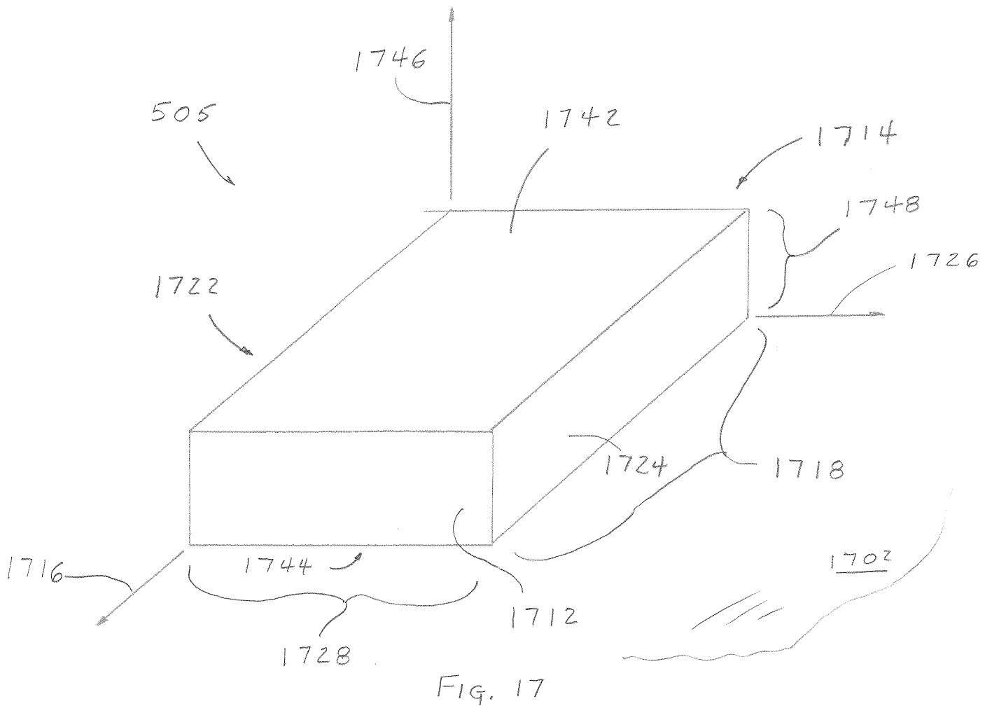

Referring now to FIGS. 1-17 and in particular FIGS. 1, 2, 5 and 17, shown is one aspect of a lawn maintenance vehicle 100. In some aspects the lawn maintenance vehicle 100 may be riding mower 105 but, as noted above, other aspects may incorporate other vehicles or devices. A lawn maintenance vehicle 100 may be adapted to operate while moving over a surface 1702 upon which maintenance operations, such as mowing or fertilizing or application of herbicide, etc. are to be performed by the lawn maintenance vehicle 100. Surface 1702 may be any of a variety of surfaces including but not limited to a lawn, a golf course green, a baseball field, a field for crops, etc. In some embodiments, the lawn maintenance vehicle 100 may comprise a plurality of wheels 112 operatively coupled to the frame 505 and adapted to support the frame 505 above a surface 1702 during operation. This latter embodiment is not limiting and an acceptable alternative to wheels 112 in some embodiments is conveyance on rollers or treads. In some embodiments, the lawn maintenance vehicle 100 may have an associated operator that rides on the lawn maintenance vehicle 100 during operation to steer it or otherwise control it. In some embodiments in which an associated operator rides on the lawn maintenance vehicle 100 during operation, the lawn maintenance vehicle 100 may comprise a seat 122 operatively coupled to the operator platform 220 and adapted for the associated operator to sit upon during operation.

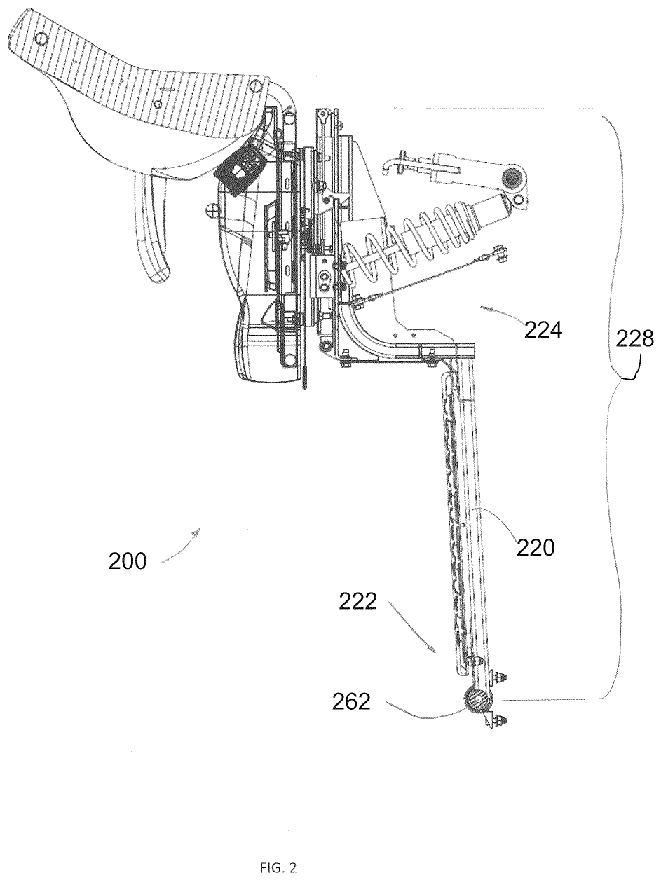

With continued reference now to FIGS. 1-17 and particularly FIGS. 2 and 5 and 17, in a first aspect a lawn maintenance vehicle 100 may comprise a frame 505. The frame 505 may have a frame front 1712 and a frame rear 1714 offset from the frame front 1712 in a depth direction 1716 by a frame depth 1718; a frame right 1722 and a frame left 1724 offset from the frame right 1722 in a width direction 1726 by a frame width 1728; and a frame top 1742 and a frame bottom 1744 offset from the frame top 1742 in a height direction 1746 by a frame height 1748.

With continued reference now to FIGS. 1-17 and particularly FIGS. 2 and 5 and 17, the first aspect of a lawn maintenance vehicle 100 may further comprise an operator suspension 200 having a platform 220. The platform 220 may have a platform front 222 and a platform rear 224 offset from the platform front 222 in the depth direction 1716 by a platform depth 228. The platform front 222 may be rotatably engaged to the frame 505 such that the platform 220 may rotate about a front support axis 262. In some embodiments, the front support axis 262 may be fixed in position with respect to the frame 505 and the platform 220. As used herein, and unless otherwise noted, position refers to location in three-space, in contrast to orientation which is the facing in three-space. For sake of illustration, a lever fixed to a fulcrum may rotate about the fulcrum such that the orientation of the level changes with respect to the fulcrum, but the position of the lever with respect to the fulcrum does not change. Accordingly, in embodiments in which the front support axis 262 is fixed in with respect to the frame 505 and the platform 220, the platform 220 is fixed in position with respect to the frame 505, but may change in orientation with respect to the frame 505.

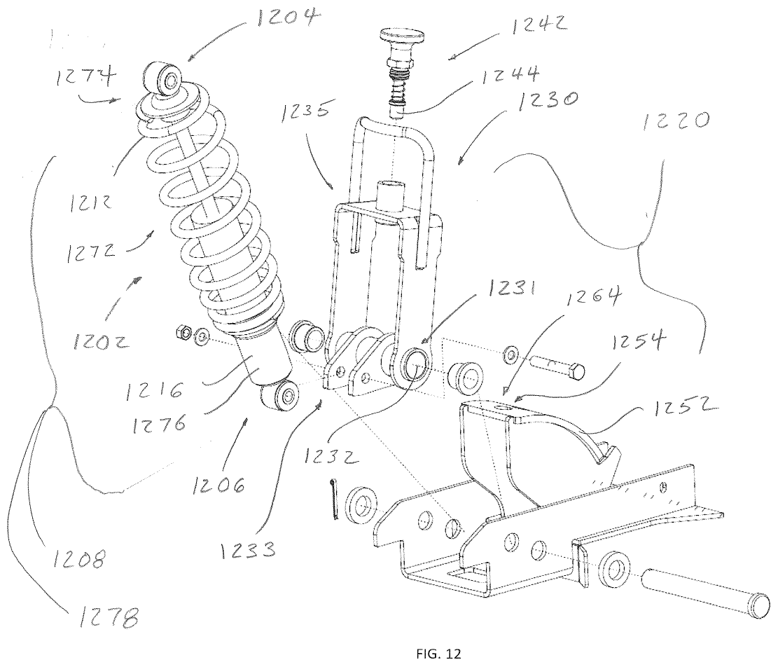

With continued reference now to FIGS. 1-17 and particularly FIG. 12, the first aspect of a lawn maintenance vehicle 100 may further comprise a spring-damper assembly 1202. The spring-damper assembly 1202 may comprise a spring-damper assembly top 1204 offset from a spring-damper assembly bottom 1206 by a variable spring-damper assembly length 1208. The spring-damper assembly top 1204 may be operationally engaged to the platform rear 224. In some aspects the spring-damper assembly top 1204 may be rotatably engaged to the platform rear 224. The spring-damper assembly bottom 1206 may be operationally engaged to an adjustment assembly 1220 described below.

With continued reference now to FIGS. 1-17 and particularly FIG. 12, the first aspect of a lawn maintenance vehicle 100 may further comprise an adjustment assembly 1220. The adjustment assembly 1220 may have an adjustment lever 1230 where the adjustment lever 1230 comprises a fulcrum 1231 pivotable about a fulcrum axis 1232, the fulcrum axis 1232 being fixed to the frame 505 such that the adjustment lever 1230 may change in orientation with respect to the frame 505 but is fixed in position with respect to the frame 505. The adjustment lever 1230 may further comprise a lever output end 1233 offset from the fulcrum 1231 by a lever output length, the lever output end 1233 may be rotatably engaged to the spring-damper assembly bottom 1206 to provide the operational engagement to the spring-damper assembly bottom 1206 noted above. The adjustment lever 1230 may further comprise a lever input end 1235 offset from the fulcrum 1231 by a lever input length, the lever input end 1235 being fixed in orientation about the fulcrum axis 1232 with respect to the lever output end 1233. It should be noted that the adjustment lever 1230 may be of the form shown in FIG. 12 in which the lever input end 1235 extends from the fulcrum 1231 to define a first vector that further defines some obtuse angle with respect to a second vector defined by the lever output end 1233 as it extends from the fulcrum 1231. This latter arrangement is not limiting and the angle between the latter referenced first vector and second vector could, in other acceptable aspects, a straight angle, a right angle or an acute angle. The lever input end 1235 may have an adjustable locking feature 1242 to permit the orientation of the lever input end 1235 to be selectably fixed with respect to the fulcrum axis 1232, and an adjustment platen 1252. The adjustment platen 1252 may be fixed in position and orientation with respect to the frame 505. As shown in FIG. 12, the adjustment platen 1252 may define a plurality of fixed lock sites 1254, wherein each lock site is 1254 adapted to operationally interface with the adjustable locking feature 1242 to lock the lever input end 1235 at a corresponding orientation with respect to the fulcrum axis 1232. In accordance with the illustrated embodiment, the adjustment platen defines five different lock sites.

It should be understood that locking the lever input end 1235 at a corresponding orientation with respect to the fulcrum axis 1232, also locks the lever output end 1233 at an orientation with respect to the fulcrum axis 1232, and thereby defines a position and orientation of the lever output end 1233 with respect to the frame 505. This then defines a position of the spring-damper assembly bottom 1206 which is operationally engaged to the lever output end 1233. Accordingly, adjustment of the lever input end, to select a lock site 1254 permits an associated operator to select one of a set of alternative discrete positions of the spring-damper assembly bottom 1206 with respect to the frame 505. In some embodiments, each lock site 1254 corresponds to a different pre-load on the spring-damper assembly 1202. In some embodiments, each lock site 1254 corresponds to a different working length for the spring-damper assembly 1202. In some embodiments, each lock site 1254 corresponds to a different rest position for the spring-damper assembly 1202. Here the rest position is the position of the spring-damper assembly top relative to the bottom thereof and can be understood as the spring-damper assembly length 1208 when not in motion. It will be appreciated that each lock site 1254 corresponds to or otherwise provides a different amount of pre-load on the spring-damper assembly 1202. In accordance with one example, the forwardmost lock site corresponds to or otherwise provides a minimum amount of pre-load, while the rearmost lock site corresponds to or otherwise provides a maximum amount of pre-load. In this example, the rearmost lock site would provide a maximum suspension stiffness, while the forwardmost lock site would provide a minimum suspension stiffness. Choice of suspension stiffness might be chosen based on operator weight and/or operator preference for a given suspension stiffness. In accordance with a preferred embodiment, the operator suspension 200 is configured to provide a set amount of suspension travel (e.g., four inches of suspension travel) regardless of the selected lock site and resultant suspension stiffness.

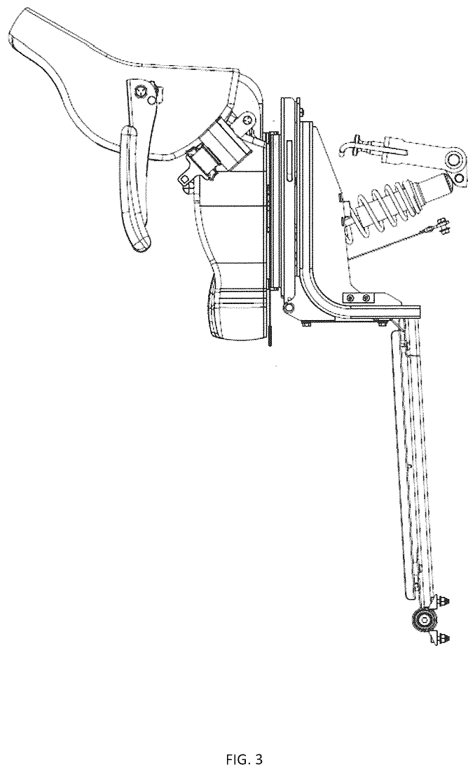

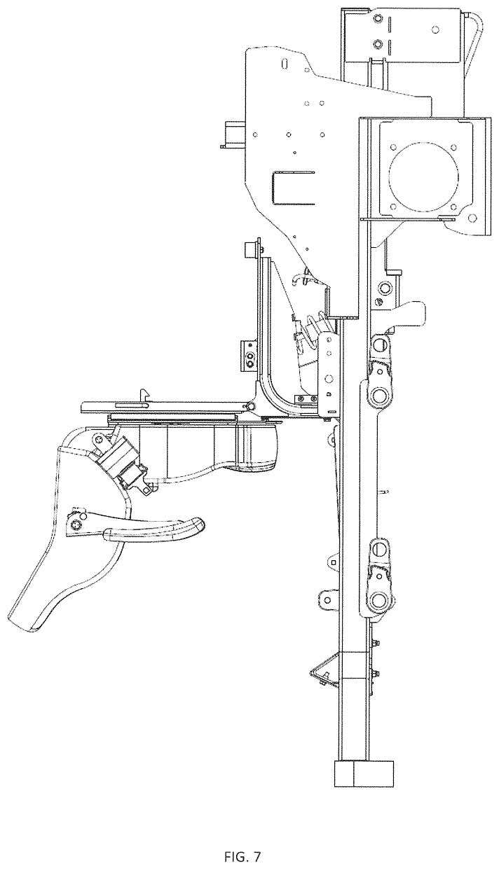

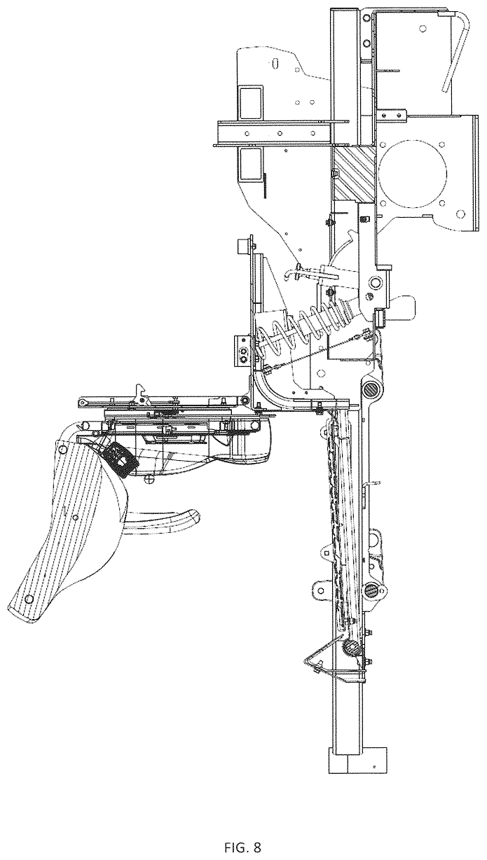

As shown in FIGS. 2, 3, 7, 8, 10, 11, and 13-15, in some embodiments of the lawn maintenance vehicle 100 the adjustment assembly 1220 is positioned under the operator seat 122. In some such embodiments, adjustment of the adjustment lever 1230 may require the operator seat 122 to be moved or lifted up to provide needed access. In some embodiments, the operator seat is engaged to the platform 220 by a hinge and latch to permit the seat to be rotated between a first configuration, as shown in FIGS. 2 and 3, and a second configuration as shown in FIGS. 7 and 8.

As shown in FIG. 12, the adjustable locking feature 1242 may have a pin 1244 adapted to be selectably engaged with any of the fixed lock sites 1254. In some embodiments, when the pin 1244 is engaged with any fixed lock site 1254, the lever input end 1235 is fixed with respect to the fulcrum axis 1232 and may thereby hold the pre-load on the spring-damper assembly 1202 fixed, or hold the working length for the spring-damper assembly 1202 fixed, or may hold the rest position for the spring-damper assembly 1202 fixed, or some combination thereof. In some embodiments, when the pin 1244 is not engaged with any fixed lock site 1254, the lever input end 1235 is free to rotate about the fulcrum axis 1232, may thereby permit the pre-load on the spring-damper assembly 1202 to be changed, or permit the working length for the spring-damper assembly 1202 to be changed, or may permit the rest position for the spring-damper assembly 1202 to be changed, or some combination thereof.

As shown in FIG. 12, the pin 1244 may be spring biased to move into an engaged position when positioned at any lock site 1254.

In some embodiments, the spring-damper assembly 1202 comprises a spring 1212 adapted to produce a restoring force in response to a displacement (increase or decrease in the spring-damper assembly length 1208) from the rest position, wherein the restoring force is a function of the spring-damper assembly length 1208 defined in part by a spring coefficient such as: Force (F)=spring coefficient (k)*displacement (x). While many springs are Hookean, such that k is constant or practically constant, some other springs are designed such that k is very different from a constant. In some aspects, the spring coefficient is constant with respect to the pre-load on the spring-damper assembly 1202; in some aspects the spring coefficient is not constant with respect to the pre-load on the spring-damper assembly 1202. In some aspects, the spring coefficient is constant with respect to the rest position of the spring in the spring-damper assembly 1202; in some aspects the spring coefficient is not constant with respect to the rest position of the spring in the spring-damper assembly 1202. Selection of a spring with a k that is a function of the rest position of the spring, which is selectable as noted above, may permit an associated user to select the natural frequency of the spring-damper assembly 1202.

In some embodiments, the spring-damper assembly 1202 comprises a damper 1216 adapted to produce a resistive force that is a function of the rate of change of the spring-damper assembly length 1208 defined in part by a damping coefficient. While many dampers have a damping coefficient (c) that is constant or practically constant, some other dampers are designed such that c is very different from a constant. In some aspects, the damping coefficient is constant with respect to the pre-load on the spring-damper assembly 1202; in some aspects the damping coefficient is not constant with respect to the pre-load on the spring-damper assembly 1202. In some aspects, the damping coefficient is constant with respect to the rest position of the spring in the spring-damper assembly 1202; in some aspects the damping coefficient is not constant with respect to the rest position of the spring in the spring-damper assembly 1202. Selection of a damper with a c that is a function of the rest position of the damper, which is selectable as noted above, may permit an associated user to select the performance of the spring-damper assembly 1202.

With further reference to FIGS. 1-17, a second aspect, provided is a riding mower 105 comprising a frame and an operator suspension 200. The operator suspension 200 may have a platform 220 having a platform front 222 and a platform rear 224 offset from the platform front 222 in the depth direction 1716 by a platform depth 228, the platform front 222 rotatably engaged to the frame 505 such that the platform 220 may rotate about a front support axis 262, the front support axis 262 being fixed in position with respect to the frame 505 and the platform 220. The operator suspension may further comprise an elongated coil-over-shock assembly 1272 (which may be one form of spring-damper assembly 1202) defining a coil-over-shock assembly top 1274 offset from a coil-over-shock assembly bottom 1276 by a variable coil-over-shock assembly length 1278. The coil-over-shock assembly top 1274 may be rotatably engaged to the platform rear 224. The coil-over-shock assembly bottom 1276 may be rotatably engaged to an adjustment assembly 1220. The adjustment assembly 1220 may have an adjustment lever 1230 having a fulcrum 1231 pivotable about a fulcrum axis 1232, the fulcrum axis 1232 fixed to the frame 505. The adjustment assembly 1220 may have a lever output end 1233 offset from the fulcrum 1231 by a lever output length, the lever output end 1233 being rotatably engaged to the coil-over-shock assembly bottom 1276, a lever input end 1235 offset from the fulcrum 1231 by a lever input length, the lever input end 1235 being fixed in orientation about the fulcrum axis 1232 with respect to the lever output end 1233, the lever input end 1235 having an adjustable locking pin 1244 to permit the orientation of the lever input end 1235 to be selectably fixed with respect to the fulcrum axis 1232, and an arcuate adjustment platen 1252 centered on the fulcrum 1231 and fixed in position and orientation with respect to the frame 505.

The adjustment platen 1252 may define a plurality of fixed holes 1264, each hole 1264 adapted to operationally receive the adjustable locking pin 1244 to lock the lever input end 1235 at a corresponding orientation with respect to the fulcrum axis 1232. Each hole 1264 may correspond to a different pre-load on the coil-over-shock assembly 1272. In some aspects, when the pin 1244 is engaged with any fixed hole 1264, the lever input end 1235 is fixed with respect to the fulcrum axis 1232 thereby holding the pre-load on the coil-over-shock assembly 1272 fixed, and when the pin 1244 is not engaged with any fixed hole 1264, the lever input end 1235 is free to rotate about the fulcrum axis 1232, thereby permitting the pre-load on the coil-over-shock assembly 1272 to be changed. In some aspects thereof, the pin 1244 is spring biased to move into a engaged position when positioned at any lock site 1254.

The riding mower 105 may further comprise a plurality of wheels 112 operatively coupled to the frame 505 and adapted to support the frame 505 above a surface 1702 during operation.

The riding mower 105 may further comprise an operator seat 122 operatively coupled to the platform 220. In some aspects thereof, the adjustment assembly 1220 is positioned under the operator seat 122.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein. As an example, an arrangement of components depicted in one embodiment can be swapped with components depicted in another embodiment, optionally excluding some components or including other components illustrated in a third embodiment, according to design creativity of one of ordinary skill in the art.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as hardware configured to implement the functions, including mechanical hardware, electronic hardware, and computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

According to the foregoing, the present subject matter may take a variety of aspects, some of which are set out expressly below. The following aspects are exemplary and are not intended to be limiting. Ordinal language (first, second, third, etc.) used in the following merely indicates examples and to avoid confusion and is not intended to express or imply any order or hierarchy.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A lawn maintenance vehicle comprising:
a frame, the frame having
a frame front and a frame rear offset from the frame front in a depth direction by a frame depth,
a frame right and a frame left offset from the frame right in a width direction by a frame width, and
a frame top and a frame bottom offset from the top in a height direction by a frame height;
an operator suspension having,
a platform having a platform front and a platform rear offset from the platform front in the depth direction by a platform depth, the platform front rotatably engaged to the frame such that the platform may rotate about a front support axis, the front support axis being fixed in position with respect to the frame and the platform,
a spring-damper assembly elongated to define
a spring-damper assembly top offset from a spring-damper assembly bottom by a variable spring-damper assembly length, the spring-damper assembly top operationally engaged to the platform rear,
the spring-damper assembly bottom operationally engaged to an adjustment assembly,
the adjustment assembly having
an adjustment lever having
a fulcrum pivotable about a fulcrum axis, the fulcrum axis being fixed to the frame,
a lever output end offset from the fulcrum by a lever output length, the lever output end being rotatably engaged to the spring damper assembly bottom,
a lever input end offset from the fulcrum by a lever input length, the lever input end being fixed in orientation about the fulcrum axis with respect to the lever output end, the lever input end having an adjustable locking feature to permit the orientation of the lever input end to be selectably fixed with respect to the fulcrum axis, and
an adjustment platen fixed in position and orientation with respect to the frame, the adjustment platen defining a plurality of fixed lock sites, each lock site adapted to operationally interface with the adjustable locking feature to lock the lever input end at a corresponding orientation with respect to the fulcrum axis; and
wherein each lock site corresponds to a different pre-load on the spring-damper assembly.

2. The lawn maintenance vehicle of claim 1, further comprising a plurality of wheels operatively coupled to the frame and adapted to support the frame above a surface during operation.

3. The lawn maintenance vehicle of claim 2, further comprising an operator seat operatively coupled to the operator platform.

4. The lawn maintenance vehicle of claim 3, wherein the adjustment assembly is positioned under the operator seat.

5. The lawn maintenance vehicle of claim 1, wherein the adjustable locking feature has a pin adapted to be selectably engaged with any of the fixed lock sites, wherein:
when the pin is engaged with any fixed lock site, the lever input end is fixed with respect to the fulcrum axis thereby holding the pre-load on the spring-damper assembly fixed, and
when the pin is not engaged with any fixed lock site, the lever input end is free to rotate about the fulcrum axis, thereby permitting the pre-load on the spring-damper assembly to be changed.

6. The lawn maintenance vehicle of claim 5, wherein the pin is spring biased to move into a engaged position when positioned at any lock site.

7. The lawn maintenance vehicle of claim 1, wherein the spring-damper assembly comprises:
a spring adapted to produce a restoring force in response to a decrease in the spring-damper assembly length, wherein the restoring force is a function of the spring-damper assembly length defined in part by a spring coefficient;
a damper adapted to produce a resistive force that is a function of the rate of change of the spring-damper assembly length defined in part by a damping coefficient.

8. The lawn maintenance vehicle of claim 7, wherein the spring coefficient is constant with respect to the pre-load on the spring-damper assembly.

9. The lawn maintenance vehicle of claim 7, wherein the damping coefficient is constant with respect to the pre-load on the spring-damper assembly.

10. The lawn maintenance vehicle of claim 7, wherein the spring coefficient is not constant with respect to the pre-load on the spring-damper assembly.

11. The lawn maintenance vehicle of claim 7, wherein the damping coefficient is not constant with respect to the pre-load on the spring-damper assembly.

12. A riding mower comprising:
a frame, the frame having
a frame front and a frame rear offset from the frame front in a depth direction by a frame depth,
a frame right and a frame left offset from the frame right in a width direction by a frame width, and
a frame top and a frame bottom offset from the top in a height direction by a frame height;
an operator suspension having,
a platform having a platform front and a platform rear offset from the platform front in the depth direction by a platform depth, the platform front rotatably engaged to the frame such that the platform may rotate about a front support axis, the front support axis being fixed in position with respect to the frame and the platform,
an elongated coil-over-shock assembly defining
a coil-over-shock assembly top offset from a coil-over-shock assembly bottom by a variable coil-over-shock assembly length,
the coil-over-shock assembly top rotatably engaged to the platform rear,
the coil-over-shock assembly bottom rotatably engaged to an adjustment assembly,
the adjustment assembly having
an adjustment lever having
a fulcrum pivotable about a fulcrum axis, the fulcrum axis fixed to the frame,
a lever output end offset from the fulcrum by a lever output length, the lever output end being rotatably engaged to the coil-over-shock assembly bottom,
a lever input end offset from the fulcrum by a lever input length,
the lever input end being fixed in orientation about the fulcrum axis with respect to the lever output end, the lever input end having an adjustable locking pin to permit the orientation of the lever input end to be selectably fixed with respect to the fulcrum axis, and
an arcuate adjustment platen centered on the fulcrum and fixed in position and orientation with respect to the frame, the adjustment platen defining a plurality of fixed holes, each hole adapted to operationally receive the adjustable locking pin to lock the lever input end at a corresponding orientation with respect to the fulcrum axis, and
wherein each hole corresponds to a different pre-load on the coil-over-shock assembly; and
a plurality of wheels operatively coupled to the frame and adapted to support the frame above a surface during operation;
an operator seat operatively coupled to the platform; and
wherein
when the pin is engaged with any fixed hole, the lever input end is fixed with respect to the fulcrum axis thereby holding the pre-load on the coil-over-shock assembly fixed, and
when the pin is not engaged with any fixed hole, the lever input end is free to rotate about the fulcrum axis, thereby permitting the pre-load on the coil-over-shock assembly to be changed.

13. The riding mower of claim 12, wherein the adjustment assembly is positioned under the operator seat.

14. The riding mower of claim 12, wherein the pin is spring biased to move into a engaged position when positioned at any lock site.

15. A method of using a lawn maintenance vehicle comprising:
providing a lawn maintenance vehicle having
a frame, the frame having
a frame front and a frame rear offset from the frame front in a depth direction by a frame depth,
a frame right and a frame left offset from the frame right in a width direction by a frame width, and
a frame top and a frame bottom offset from the top in a height direction by a frame height,
an operator suspension having,
a platform having a platform front and a platform rear offset from the platform front in the depth direction by a platform depth, the platform front rotatably engaged to the frame such that the platform may rotate about a front support axis, the front support axis being fixed in position with respect to the frame and the platform,
a spring-damper assembly elongated to define
a spring-damper assembly top offset from a spring-damper assembly bottom by a variable spring-damper assembly length, the spring-damper assembly top operationally engaged to the platform rear,
the spring-damper assembly bottom operationally engaged to an adjustment assembly,
the adjustment assembly having
an adjustment lever having
a fulcrum pivotable about a fulcrum axis, the fulcrum axis being fixed to the frame,
a lever output end offset from the fulcrum by a lever output length, the lever output end being rotatably engaged to the spring damper assembly bottom,
a lever input end offset from the fulcrum by a lever input length, the lever input end being fixed in orientation about the fulcrum axis with respect to the lever output end, the lever input end having an adjustable locking feature to permit the orientation of the lever input end to be selectably fixed with respect to the fulcrum axis, and
an adjustment platen fixed in position and orientation with respect to the frame, the adjustment platen defining a plurality of fixed lock sites, each lock site adapted to operationally interface with the adjustable locking feature to lock the lever input end at a corresponding orientation with respect to the fulcrum axis, and
wherein each lock site corresponds to a different pre-load on the spring-damper assembly; and
changing the pre-load on the spring-damper assembly.

16. The method of using a lawn maintenance vehicle of claim 15, wherein changing the pre-load on the spring-damper assembly further comprises rotating the lever output end about the fulcrum.

17. The method of using a lawn maintenance vehicle of claim 16, wherein changing the pre-load on the spring-damper assembly further comprises selectably fixing the orientation of the lever input end with respect to the fulcrum axis.

18. The method of using a lawn maintenance vehicle of claim 17, wherein changing the pre-load on the spring-damper assembly further comprises operationally interfacing the adjustable locking feature to to a fixed lock site to lock the lever input end at a corresponding orientation with respect to the fulcrum axis.
